(19) United States
(12) Patent Application Publication
(10) Pub. No.: US 2022/0237650 A1
(43) Pub. Date: Jul. 28, 2022

(54) BOOKING CALENDAR WITH AUTOMATIC DISCOUNT APPLICATION AND CLIENT NOTIFICATION

(71) Applicants: Yaniv Holin, Boca Raton, FL (US); Beny Molayev, Lawrence, NY (US)

(72) Inventors: Yaniv Holin, Boca Raton, FL (US); Beny Molayev, Lawrence, NY (US)

(21) Appl. No.: 17/523,788

(22) Filed: Nov. 10, 2021

Related U.S. Application Data
(60) Provisional application No. 63/111,657, filed on Nov. 10, 2020.

(51) Int. Cl. G06Q 30/02; G06Q 10/10

(52) U.S. Cl. CPC G06Q 30/0235; G06Q 30/0224; G06Q 10/1093

(57) ABSTRACT

An appointment calendar system provides services by a service provider to clients or customers with the system comprising a dynamic data base of total available service time for a selected period of time, wherein the service time is allocated to selected personnel who provide services. The calendar system provides appointments for selected services for allocated times and for blocking off service time periods within the selected period of time and maintains a dynamic total of blocked off service time periods as a percentage of the total available service time. A percentage of blocked off service time of the total service time is dynamically compared to a preset table of discount percentages in the calendar system to provide a preset discount offered to customers or clients for at least one of services and related products and for Deals/Packages at different levels of calendar capacity or booked time percentages.

This application takes priority from application U.S. Ser. No. 63/111,657, filed Nov. 10, 2020, the disclosure of which is included herein in its entirety by reference thereto.

### FIELD OF THE INVENTION

This invention relates to a system for booking calendar appointments for businesses which provide time services and scheduling. The invention relates to automatic notification for providing client services and particularly with auto calendar capacity analysis and auto discounts applied as a function of available booking time.

### BACKGROUND

Calendar programs and apps for service-providing businesses, as well as related products, generally determine open or available time for a particular service and arrange for scheduling an appointment. Such service providing businesses include hair salons, cosmeticians, nail salons, car repair and the like. Walk-in business is accommodated on an available time basis, though some businesses with an active practice require only appointment scheduling. Any sales and/or discounts offered to clients or prospective clients are generally made on an ad hoc basis, in order to stimulate business. Such discount offers are often made without consideration of appointments and scheduling except to the extent of an absence of business or a need to more efficiently use available personnel.

### SUMMARY

It is an object of the present invention to provide discount applications for a service-providing business coupled with a running analysis of available business resources for determination of extent and time of discount effective application for the payment of services and related products.

It is a further object of the invention to provide automatic notification to client/customers of availability of discounts and parameters of extent and time limits of availability.

Generally, the present invention comprises an operational system for a dynamic auto analysis of service business calendar with calculation of booked appointments and free time for the providing of physical services and optionally of related products, based on the available working hours of a service team, as well as on an individual team member level. Calendar booked and free times are represented in terms of percentage of available time and in terms of actual booking. In a further embodiment, walk-in customers and clients are similarly calculated with respect to available time and business calculated discounts.

In an embodiment of the invention an appointment calendar system provides services to clients or customers with the system comprising:
i) a dynamic data base of total available service time for a selected period of time, wherein the service time is allocated to selected personnel who provide services;
ii) a calendar system configured to provide appointments for selected services for allocated times from the preset table and for blocking off service time periods (i.e., booked time) within the selected period of time;
iii) the calendar system being further configured to maintain a dynamic total of blocked off service or booked time periods as a percentage of the total available service time (booked time and free time);

The percentage of blocked off service time of the total service time is dynamically compared to a preset table of discount percentages in the calendar system to provide a preset discount offered to customers or clients for at least one of services and related products and for Deals/Packages at different levels of calendar capacity or booked time percentages.

In an embodiment, determination of time for making booking appointments is made in conjunction with a preset table of allocated times for each of selected services provided by the selected personnel. To account for constant changes in booked time relative to total and free time, discount percentages are, in some embodiments, offered for pre-determined time periods with specified expiration dates.

In operational embodiments, the system is configured to automatically send notifications such as by email or SMS text messages to existing clients or customers and/or to prospective clients and customers, with details of discount percentages and effective time periods.

Available hours of service team members (both individually and as a group) are defined and allocated according to calendar bookings with a calculated dynamic running percentage. The type of service booking is optionally correlated to expertise or preference of service team members and required products inventory for services (whether for immediate use or as available for being offered to customers). Typical times allotted for specific services are set and tabulated.

In accordance with the invention, an Auto Calendar with Capacity Analysis is created which allows service-providing businesses to create basic rule levels for Services (i.e., Appointments) and Products and Deals/Packages. These basic rule levels are conditioned on defined business conditions with automatic discounts based on business decisions/setting that are given when a booked calendar is less than a set percentage value of booked calendar time as originally defined by the business management (or as periodically updated).

In addition, other rules define what discounts will be given automatically when a calendar block is between a range of certain percentages that are defined by the businesses, for booked calendar time.

As a prudent consideration, automatic discounts are given only between the dates that are defined as Start Date and End Date. The Auto Calendar analysis and Auto Discounts repeats the process, based on the value that is set for the number of days to repeat.

Per the above and for a selected date or date range, the automatic discounts are given automatically to users while making new booking appointments, as well as when finalizing checkout payments. In addition, when Auto Calendar rules become active, the system sends automatic updates to all clients through Emails and Text Messages (SMS). The Auto calendar automatic updates (email and SMS) have a predefined template with Subject line and Body message, where there are fields that are dynamically taken from the system and used as part of the email and SMS.

Exemplary dynamic fields (for example for a Salon, which can be correspondingly modified as appropriate, depending on the types of services being provided) include:
[customer_first_name] Will enter automatically client First Name in email and SMS
[customer_last_name] Will enter automatically client last name in email and SMS
[salon_name] Will enter automatically Salon Name in the email and SMS
[services] Will enter automatically Services Discount (%) based on the pre-determined settings, in the email and SMS
[products] Will enter automatically Products Discount (%) based on the pre-determined setting in the email and SMS
[Deal/Packages] Will enter automatically Deals/Packages Discount (%) based on the predetermined setting in the email and SMS
[salon (or other service provider)_phone_number] Will enter automatically Salon Phone Number in the email and SMS, as defined in the business and location settings.

As an operational example, the following is a typical listing of hair styling and haircut and barber services with determined and set duration times as used in the calculation of discount offers and appointment times for relevant service. The system is formulated to create any type of service on the fly without the need of coding, and businesses have the option to create their own services, categories and define their duration and pricing, with full flexibility:

| | | Dura- |
|---|---|---|
| | | tion |
| | | (Min- |
| Category | Service Name | utes) |
| Hair Styling Services | Shampoo | 10 |
| Hair Styling Services | Shampoo + Blow Dry | 30 |
| Hair Styling Services | Shampoo + Blowout | 38 |
| Hair Styling Services | Shampoo + Conditioner + Blow Dry | 40 |
| Hair Styling Services | Shampoo + Deep Conditioning | 63 |
| | Mask + Blow Dry | |
| Hair Styling Services | Shampoo + Deep Conditioning | 60 |
| | Mask + Blowout | |
| Hair Styling Services | Conditioning Treatment | 15 |
| Hair Styling Services | Deep Conditioning Treatment | 25 |
| Hair Styling Services | Detangling Treatment | 25 |
| Hair Styling Services | Men's Wash + Haircut + Blowout | 40 |
| Hair Styling Services | Children's Wash + Haircut + | 48 |
| | Blowout | |
| Hair Styling Services | Women's Wash + Haircut + Blowout | 60 |
| Hair Styling Services | Blow Dry | 40 |
| Hair Styling Services | Blowout & Style | 50 |
| Hair Styling Services | Blow Dry + Flat Iron | 50 |
| Hair Styling Services | Blow Dry + Curling Iron | 50 |
| Hair Styling Services | Flat Iron | 10 |
| Hair Styling Services | Curling Iron | 10 |
| Hair Styling Services | Hair Updo (partial) | 15 |
| Hair Styling Services | Hair Updo (full Head) | 30 |
| Haircut & Barber Services | Full Head Shave | 20 |
| Haircut & Barber Services | Afro Men's Haircut | 15 |
| Haircut & Barber Services | Afro Men's Haircut + Blow Dry | 30 |
| Haircut & Barber Services | Child's Trim | 5 |
| Haircut & Barber Services | Child's Haircut | 15 |
| Haircut & Barber Services | Child's Bang Trim | 5 |
| Haircut & Barber Services | Child's Haircut + Blow Dry | 35 |
| Haircut & Barber Services | Child's Haircut + Styling | 30 |
| Haircut & Barber Services | Child's Blowout | 20 |
| Haircut & Barber Services | Men's Trim | 10 |
| Haircut & Barber Services | Men's Haircut | 15 |
| Haircut & Barber Services | Men's Haircut + Blow Dry | 40 |
| Haircut & Barber Services | Men's Haircut + Shave | 40 |
| Haircut & Barber Services | Men's Haircut + Beard Trim | 30 |

Further operation of the present system will become clearer in light of the following description and drawings in which:

### SHORT DESCRIPTION OF THE DRAWINGS

FIGS. 1-16 illustrate data entry pages for service-providing businesses with operational aspects of the invention wherein:

FIGS. 1-7 depict an Analysis Discount Email Settings page with descriptions of operation:

FIG. 1 indicates activation of Enable and Disable functions of the Auto Calendar Analysis modules;

FIGS. 2-4, show the entry of Start and End Date for analysis of booked time and calculation of discounts;

FIG. 5 illustrates the calculation of Calendar Booked time percentage+Calendar free time percentage based on the selected dates;

FIG. 6 follows with the step of selecting the period for re-analyzing and re-calculating calendar booked and free time and executing the defined auto discounts rules and client notifications;

FIGS. 7 and 8 provide a detailed report of calendar booked time in percentage and in hours with percentages of calendar free time and hours for each employee;

FIG. 9 shows the activation and enablement of toggle buttons with rules and discounts being active and in effect and with client customers automatically receiving Email and SMS information;

FIG. 10 illustrates available rules and levels for each of services, products and deals/packages;

FIG. 10A shows an example of drop downs for entry of both percentage of booking time and related discount percentage.

FIG. 11 provides options for advising customer clients of discounts;

FIG. 12 shows Email templates and SMS templates for sending to customer clients;

FIG. 13 depicts a test email review option;

FIG. 14 depicts a test SMS review option;

FIG. 15 shows auto-calendar services discounts when new appointments are created;

FIG. 16 shows automatic product discounts when adding products, deals and packages on the checkout section; and

FIGS. 17A-D depict typical services provided with a hair salon embodiment.

### DETAILED DESCRIPTION

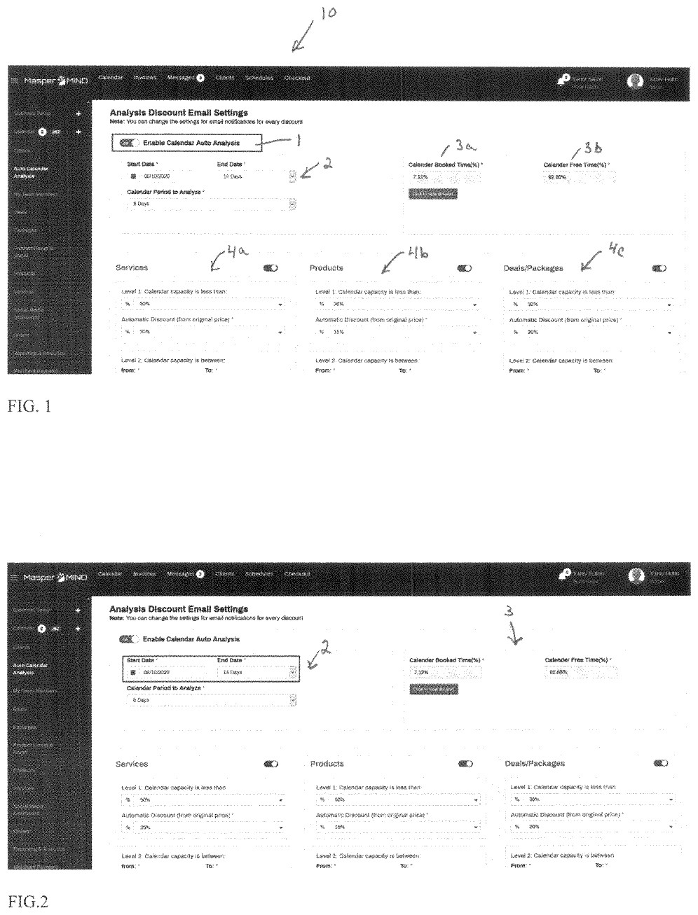

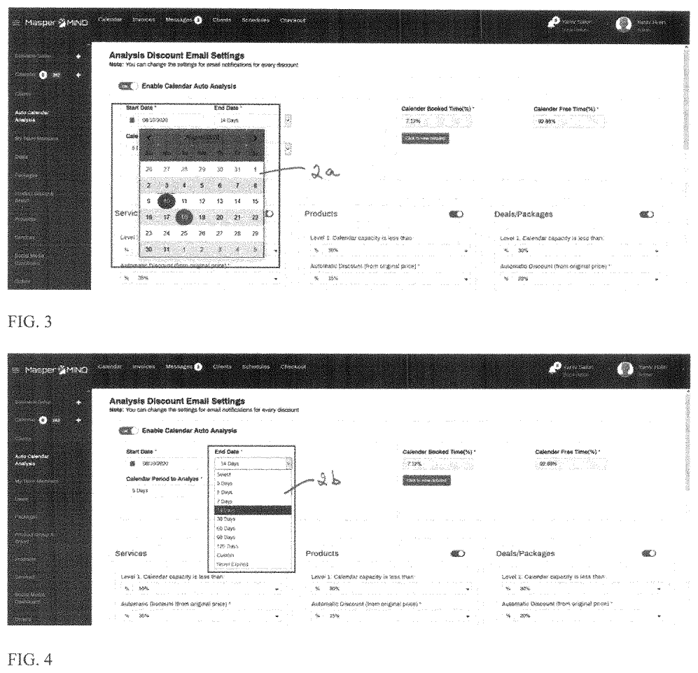

FIG. 1 shows operation of the system with data entry page 10 having field 1 for enabling calendar auto analysis. Field 2 provides for start date and end date and calendar period to analyze for determining discount level. Field 3a provides percentage of calendar booked time in the selected time period and field 3b provides calendar fee time for the selected time period. Fields 4a, 4b and 4c provide correlative percentages of calendar capacity (booked time) with automatic discounts (as preselected) for different value levels for Services (Field 4a); Products (Field 4b) and Deals/Packages (Field 4c) respectively. FIG. 1 shows field 1 having been activated for initial discount application analysis of the system. FIG. 2 depicts entry of start and end dates in field 2 with calendar period to analyze for booked and free time as displayed in field 3. Entry of the time period for analysis is effected with drop down calendar 2a in FIG. 3 or drop down time period selector 2b in FIG. 4. The Start and End Date enable businesses to check their Calculations of Calendar Booked Time and Calendar Free time. When clicking on Start Date a calendar is opened and a start date can be chosen. When clicking on End Date a dropdown with multiple duration options becomes available with additional options of entering a specific end date from calendar or an option to choose ‘Never Expired’ which mean there is no end date and the Auto Calendar Analysis will continue to run.

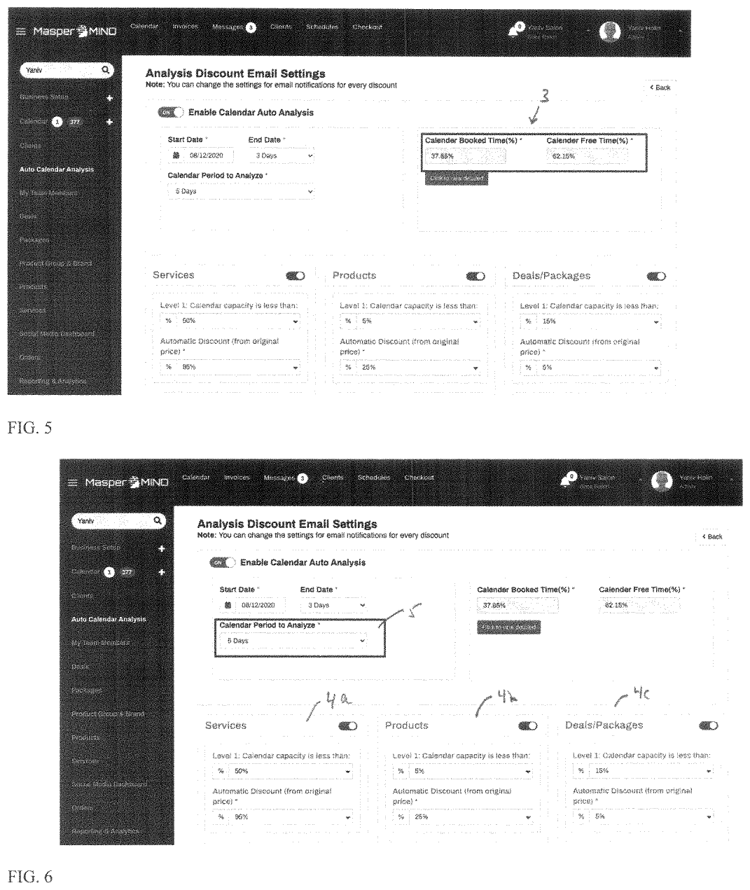

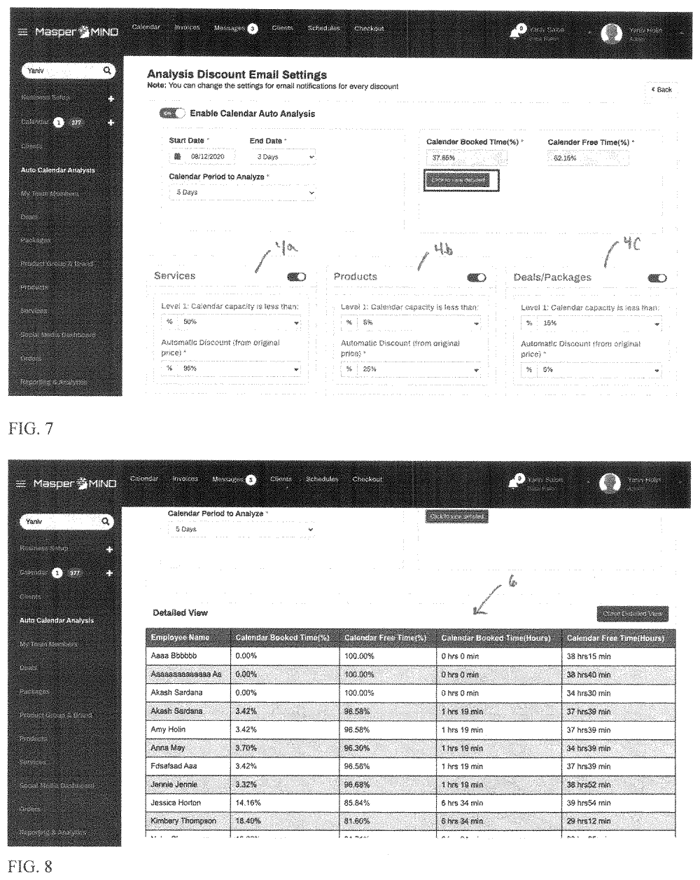

As shown In FIG. 5, the Auto Calendar Analysis shows Calendar Booked time percentage+Calendar free time percentage based on the selected dates in field 3. At this point, as shown in FIG. 6, the period for re-analyzing and re-calculating calendar booked and free time is selected in field 5 and thereby executes the defined auto discounts rules and clients notifications with results shown in FIG. 4a-c. Detailed reports of Calendar Booked Time in Percentage and in hours plus Calendar Free time in percentage and hours for each Employee are exemplified in chart 6 in FIG. 8.

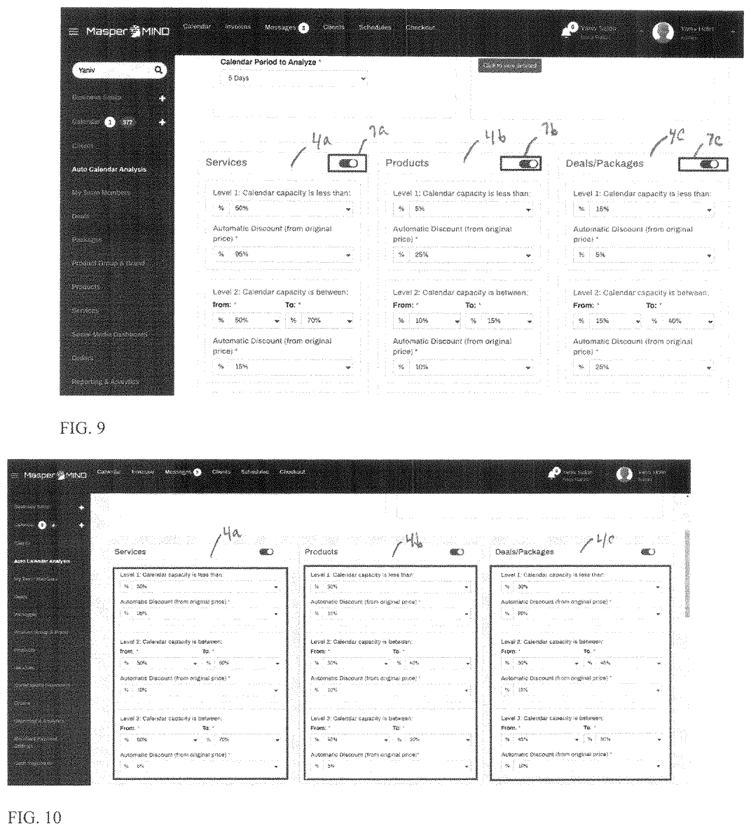

Activation and enablement of the toggle buttons results in the rules and discounts being active and take place as shown in field 4a-c in FIG. 9 and clients will automatically receive emails and SMS informing them about the discounts. Emails+SMS will only be send when the toggles buttons 7a-c are enabled.

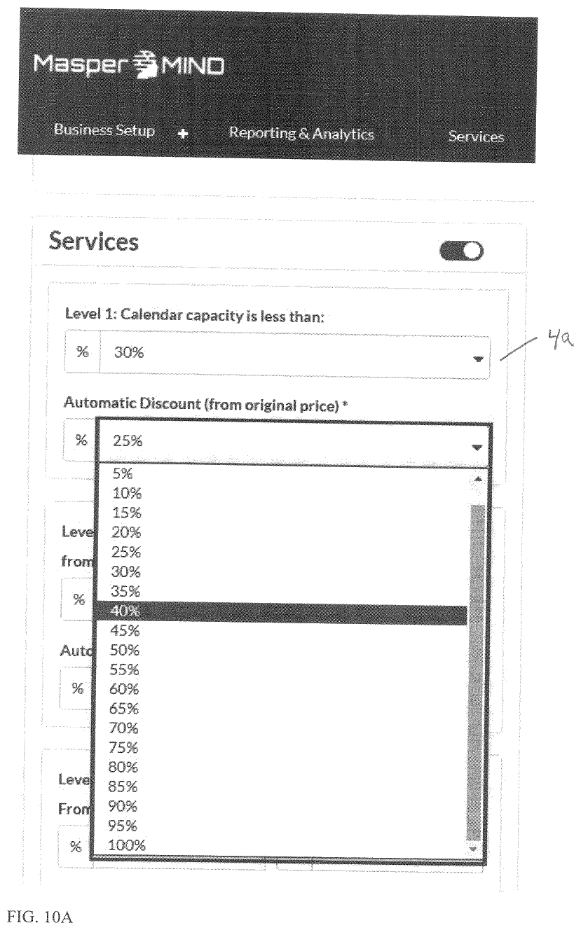

As shown in FIG. 10, businesses are able to enable or disable Auto Calendar functionality for Services, Products. Deals and Packages.
a. At this point it is possible to set up to 3 rules per category 8a-c (Services, Products, Deals/Packages, respectively).
b. The rules automatically calculate the Calendar Booked Percentage and the Automatic Discounts (for each of the categories in tables 8a-c) that are set become automatically active, once the rules values are met.
c. Rules have different pre-set levels wherein at:
   i. Level 1: If Calendar booked is less than [value %] then automatic discount will be [S value]
   ii. Level 2: If Calendar booked is between [value %]−[value %] then automatic discount will be [S value]
   iii. Level 3: If Calendar booked is between [value %]−[value %] (other than value in Level 2) then automatic discount will be [S value].

FIG. 10A illustrates in close-up view the drop down option for setting discount levels for booking level percentages.

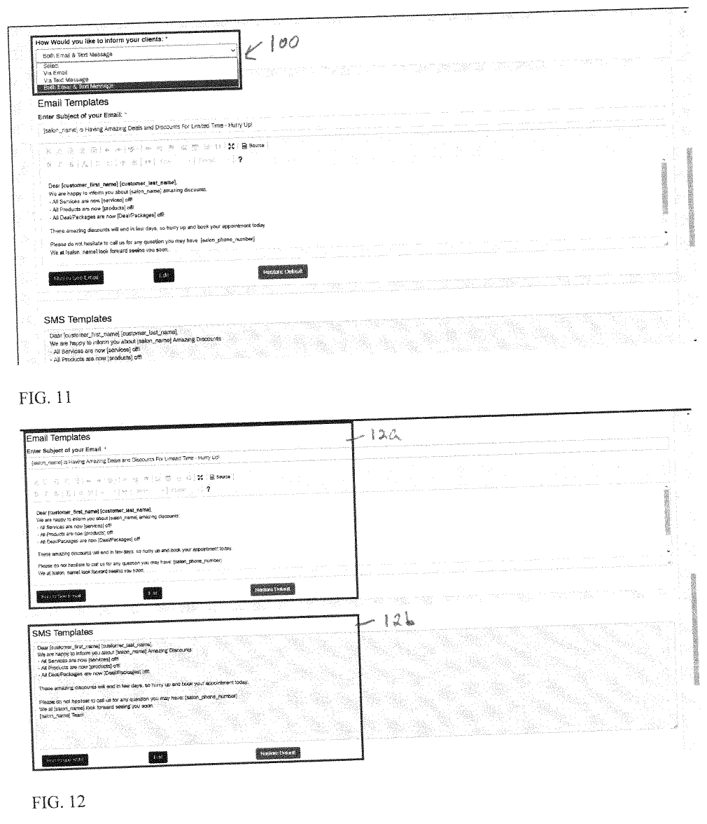

In FIG. 11, an enabled page appears which permits a decision regarding how to inform clients or customers about the Auto Discounts by Email, or by SMS or by both with selection at field 10.

FIG. 12 shows in fields 12a and 12b that businesses have the option to use email and SMS Editors or to use the predefined templates.

The Auto calendar automatic notifications (email and SMS) have a predefined template with Subject line and Body message.

There are dynamic fields, as described above, that are filled automatically from a data base of the system and are used as part of the email and SMS, These are the list of short codes that businesses can use in email and SMS Templates for dynamic Name, Discount Percentage, business Phone Number, business name (salon used as an example):
[customer_first_name] Will automatically client first name in email and SMS
[customer_last_name] Will automatically enter client last name in email and SMS
[salon_name] Will automatically enter Salon Name in the email and SMS
[services] Will automatically enter Services Discount (%) based on the above setting in the email and SMS
[products] Will automatically enter Products Discount (%) based on the above setting in the email and SMS
[Deal/Packages] Will automatically enter Deals/Packages Discount (%) based on the above setting in the email and SMS
[salon_phone_number] Will automatically enter Salon Phone Number in the email and SMS, as defined in the business and location settings.

Clients that get the emails notification and SMS notification will have the option to click on a hyperlink that will take them to businesses website provided and will be able to book and pay service appointments, products, deals and packages.

If businesses select editing the predefined templates for both Email and/or SMS then they have the option to restore the predefined template by selecting ‘Restore Default’.

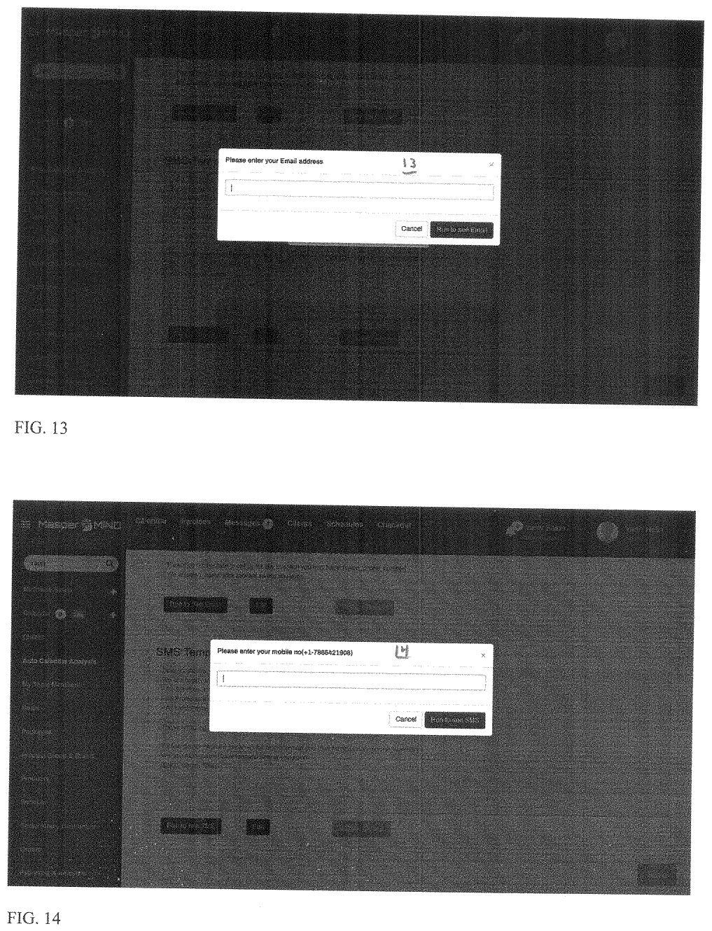

As a check for editing or reviewing emails and SMS texts, FIGS. 13 and 14 show fields 13 and 14 respectively which permit entry of email and SMS data to do so. Business can select ‘Run to See Email’ in FIG. 13, which will then allow entry of an email address in order to send a test email with the selected email template, so that it can be reviewed before emails are sent to all clients/customers. Businesses can select ‘Run to See SMS’ in FIG. 14, which will then allow entry of a mobile number in order to send a test SMS with the selected SMS template, so that it can be reviewed before texts are sent to all clients/customers.

FIG. 15 provides a page 15 with booking details including field 15a with auto calendar automatic Services Discounts shown automatically when creating new appointments on Calendar Appointments section 15b.

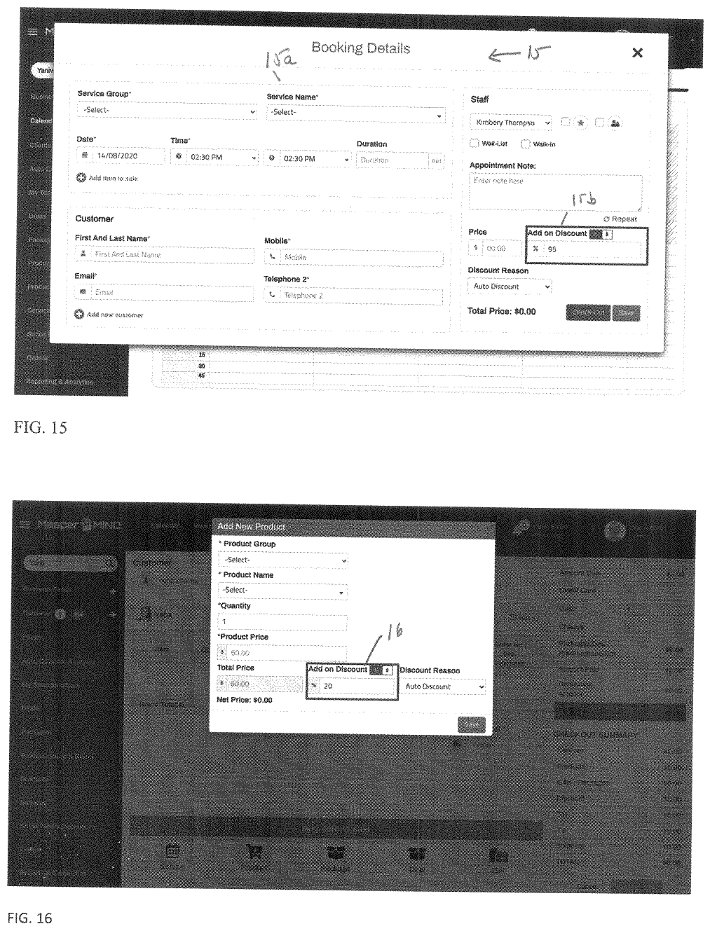

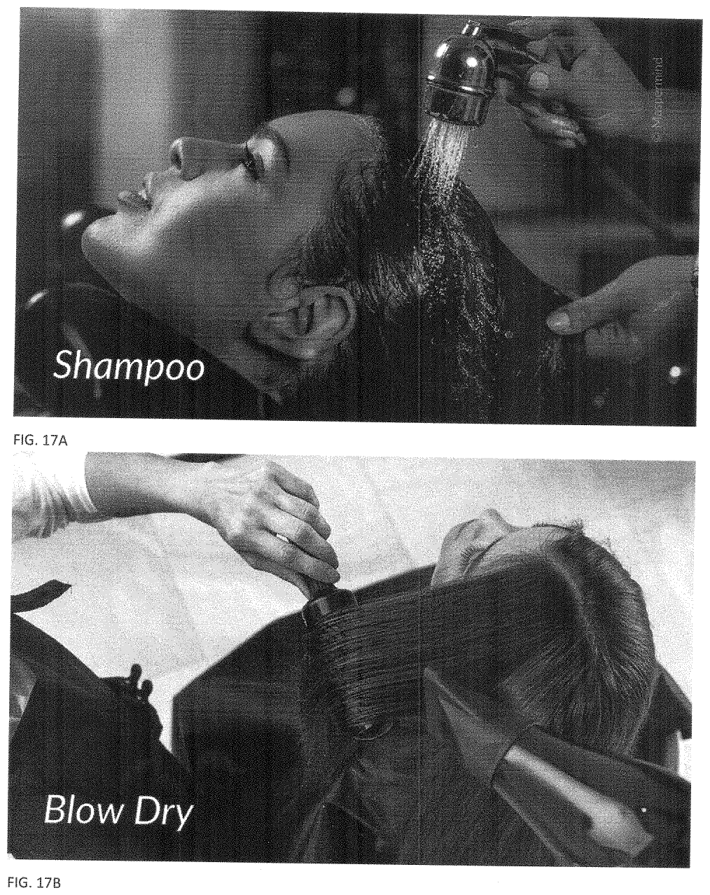

FIG. 16 shows that Auto calendar automatic Products discounts are automatically applied at field 16 when adding Products, Deals and Packages on a Checkout section.

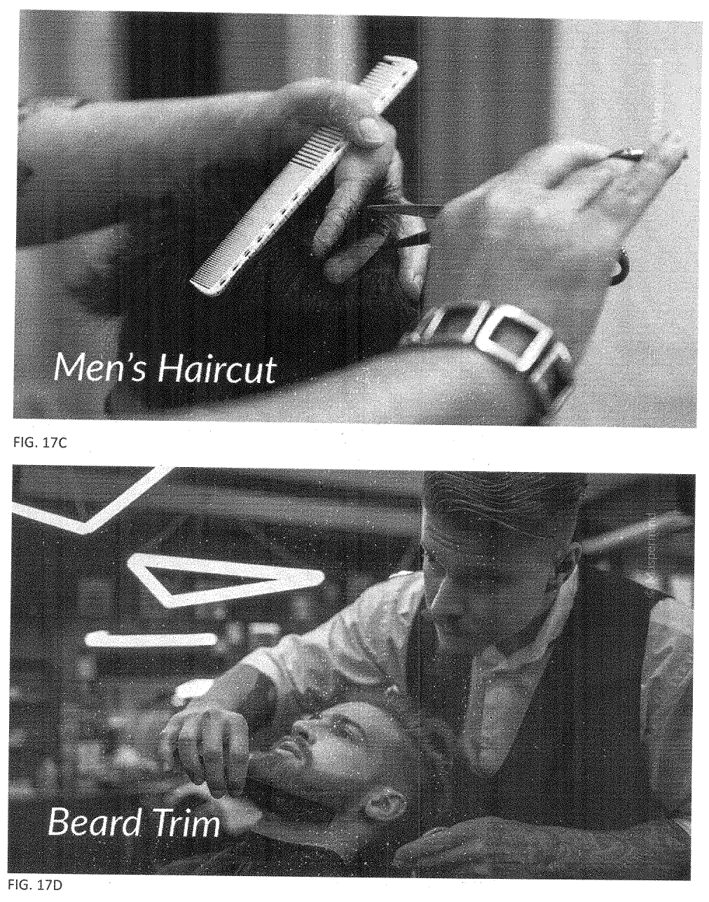

As exemplary of the services but not as a limiting description, FIG. 17A depicts a typical shampoo service which, according to the above table requires an appointment blocking time of at least 10 minutes. Similarly, FIG. 17B depicts a blow dry service with styling which requires a blocking appointment time of at least 40 minutes. FIG. 17C shows a typical men's haircut with an appointment blocking time of at least 15 minutes and FIG. 17D shows a typical beard trim with a blocking appointment time of at least 10 minutes.

It is understood that the above description and examples are merely illustrative of the invention and that changes in types of services provided and concomitant adaptations and the like are possible without departing from the scope of the invention as set forth in the following claims.

What is claimed is:

1. An appointment calendar system for providing services by a service provider to clients or customers with the system comprising:
iv) a dynamic data base of total available service time for a selected period of time, wherein the service time is allocated to selected personnel who provide services;
v) a calendar system configured to provide appointments for selected services for allocated times and for blocking off service time periods within the selected period of time;
vi) the calendar system being further configured to maintain a dynamic total of blocked off service time periods as a percentage of the total available service time;
wherein the percentage of blocked off service time of the total service time is dynamically compared to a preset table of discount percentages in the calendar system to provide a preset discount offered to customers or clients for at least one of services and related products and for Deals and Packages at different levels of calendar capacity or booked time percentages.

2. The appointment calendar system of claim 1, wherein the system includes a preset table of allocated times for each of selected services provided by the selected personal which table is used to determine blocking off service time periods.

3. The appointment calendar system of claim 1, wherein the preset discount is calculated and offered when blocked off service time is below a pre-selected percentage of total available service time.

4. The appointment calendar system of claim 1, wherein the preset discount is calculated and offered when blocked off service time of total available service time percentage. is within a pre-selected percentage range.

5. The appointment calendar system of claim 1, wherein the service provider provides services selected from those provided by hair salons, cosmeticians, nail salons and car repair establishments.

6. The appointment calendar system of claim 5, wherein the services provided are selected from those provided by hair salons.

7. The appointment calendar system of claim 1, wherein, when a preset discount is calculated, the system is configured to communicate details of the discount and duration to any or all of clients, customers and prospective clients and customers of the service provider.
